(19) United States
(12) Patent Application Publication
(10) Pub. No.: US 2018/0119940 A1
(43) Pub. Date: May 3, 2018

(54) INTELLIGENT ENERGY-SAVING LED FLOOD LIGHT

(71) Applicant: DONGGUAN THAILIGHT SEMICONDUCTOR LIGHTING CO., LTD, Dongguan (CN)

(72) Inventor: Wenbo ZHOU, Dongguan (CN)

(73) Assignee: DONGGUAN THAILIGHT SEMICONDUCTOR LIGHTING CO., LTD, Dongguan (CN)

(21) Appl. No.: 15/684,923

(22) Filed: Aug. 23, 2017

(30) Foreign Application Priority Data
Oct. 28, 2016 (CN) 201621185375.0

(51) Int. Cl. F21V 29/76; F21V 21/116

(52) U.S. Cl. CPC F21V 29/76; F21Y 2115/10; F21V 21/116

(57) ABSTRACT

The invention discloses an intelligent energy-saving LED flood light, including a housing, a LED light board arranged on the upper surface of the housing, and a power supply component which is electrically connected with the LED light board. A power supply case accommodating the power supply component and a row of spaced radiating plates are provided on the lower surface of the housing. A row of protruding bars is provided on the bottom wall of the power supply case. A power supply cover plate is provided in the power supply case, and radiating ribs are provided on the outer wall of the power supply cover. The intelligent energy-saving LED flood light of the invention has reasonable structure design and good heat dissipation effect.

### CROSS REFERENCE TO RELATED APPLICATIONS

This application is based upon and claims priority to Chinese Patent Application No. CN201621185375.0 (CN), filed on Oct. 28, 2016, the entire contents of which are incorporated herein by reference.

### TECHNICAL FIELD

The invention relates to the field of electrical appliances, particularly to an intelligent energy-saving LED flood light.

### BACKGROUND OF THE INVENTION

Flood lights are designed to illuminate an area to have illuminance above the surrounding environment. The flood lights are mainly used for large areas like operating mines, outline of buildings, stadiums, overpasses, monuments, green landscape lightings, bars, dance halls and so on. As a new generation of lighting source, the LED has advantages such as high brightness, low power consumption, long service life, quick start, small size, environmental friendliness, adjustability etc., and thus is more and more widely used. With the development and progress of high-power LED technology, there have been more and more flood lights using LED as a lighting source.

Nowadays, the available LED flood light generally has a closed space, which has disadvantages such as complex structure, slow heat dissipation, inconvenient assembly and disassembly, short service life, and difficulty in adjusting the angle, and thus affects the lighting effect. At the same time, the flood light mainly uses the silicone waterproof strip to fill the gaps between the glass and the light housing, so as to achieve the required standard waterproof level of the light. The waterproof glue is then filled to achieve the waterproofing. However, in the prior art, the glass is difficult to be compressed and controlled, so the required level of the standard cannot be reached, resulting in a poor waterproofing.

### SUMMARY OF THE INVENTION

In order to overcome the deficiencies of the prior art, the objective of the invention is to provide an intelligent energy-saving LED flood light, which has reasonable structural design and good heat dissipation effect.

The objective of the invention is realized by the technical solutions as below:

An intelligent energy-saving LED flood light, comprising a housing, an LED light board arranged on an upper surface of the housing, a power supply component electrically connected to the LED light board. A power supply case, accommodating the power supply component and a row of spaced radiating plates, is provided on a lower surface of the housing. The power supply case comprises a case body and a corresponding supply power cover; a row of protruding bars is provided on a bottom wall of the case body, wherein the power supply component and the bottom wall of the case body are separated by the protruding bars; and radiating ribs are provided on an outer wall of the power supply cover.

Preferably, the case is hermetically connected to the power supply cover, which can prevent water from entering into the power supply case, and thus improves the waterproof capability of the flood light.

Preferably, a plurality of drainage holes are provided on the upper surface of the housing. The drainage holes can prevent the rainwater from depositing on the upper surface of the housing, and thus avoid the infiltration of rainwater into the LED light board.

Preferably, the intelligent energy-saving LED flood light further comprises a bracket, and both ends of the bracket are connected to the housing. The bracket mainly serves to support the LED flood light, besides, the LED flood light can be fixed to the street light or the building through the bracket.

Preferably, two engaging lugs are symmetrically provided on both sides of the housing, and two mounting holes are symmetrically provided in the two engaging lugs, and both ends of the bracket are connected to the engaging lugs through the mounting holes.

Preferably, a plurality of strengthening ribs are provided on the radiating plates. The strengthening ribs can improve the strength of the radiating plate.

Preferably, the bracket is L-shaped, and the bracket is formed by hinging two straight arms. And the angle of the hinge connection is adjustable. By adjusting the angle of the hinge connection, it is convenient to adjust the illumination angle of the LED flood light.

Compared with the prior art, the advantages of the invention are provided as below:

1. The intelligent energy-saving LED flood light of the invention is provided with a row of radiating plates on the lower surface of the housing of the LED flood light, to enhance the cooling capacity of the flood light; next, a row of protruding bars are provided on the bottom wall of the case body, and a radiating rib is provided on the outer wall of the power supply cover, so that the cooling capacity of the flood light is further enhanced to prevent the power supply from overheating and burning out.

2. The intelligent energy-saving LED flood light of the invention is provided with a plurality of drainage holes in the upper surface of the housing, so as to facilitate the rapid discharge of rainwater and avoid the infiltration of rainwater into the LED light board; the gap between the power supply cover plate and the case body is sealed, to improve the waterproof effect.

3. The intelligent energy-saving LED flood light of the invention, wherein the bracket can be formed by hinging two straight arms, and the angle of the hinge connection is adjustable. By adjusting the angle of the hinge connection, it is convenient to adjust the illumination angle of the LED flood light.

### BRIEF DESCRIPTION OF THE DRAWINGS

FIG. 1 is a structural schematic view of the embodiment 1 of the invention;

FIG. 2 is an explosive schematic view of the embodiment 1 of the invention;

FIG. 3 is a schematic view of a housing and a power supply case in the embodiment 1 of the invention;

FIG. 4 is a structural schematic view of a power supply cover plate of the embodiment 1 of the invention;

FIG. 5 is a structural schematic view of the embodiment 2 of the invention;

In the drawings:

10, housing; 11, drainage hole; 12, radiating plate; 121, strengthening rib; 13, engaging lug; 131, mounting hole; 20, LED light board; 30, power supply case; 31, protruding bars; 32, power supply cover; 321, radiating rib; 33, sealing ring; 40, U-shaped bracket; 41, L-shaped bracket.

### DETAILED DESCRIPTION OF THE EMBODIMENTS

The invention will be further described with the drawings and the embodiments as below:

### Embodiment 1

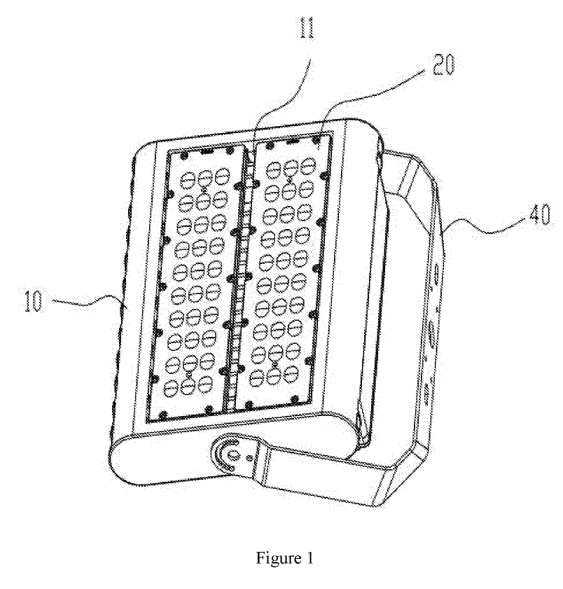

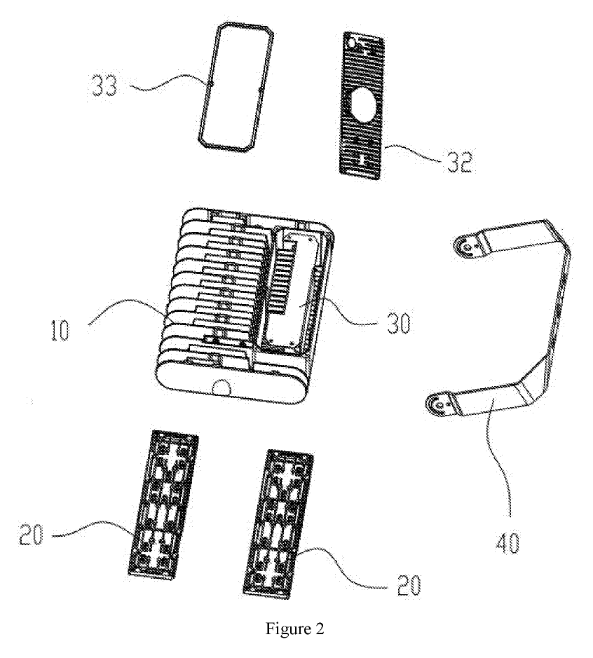

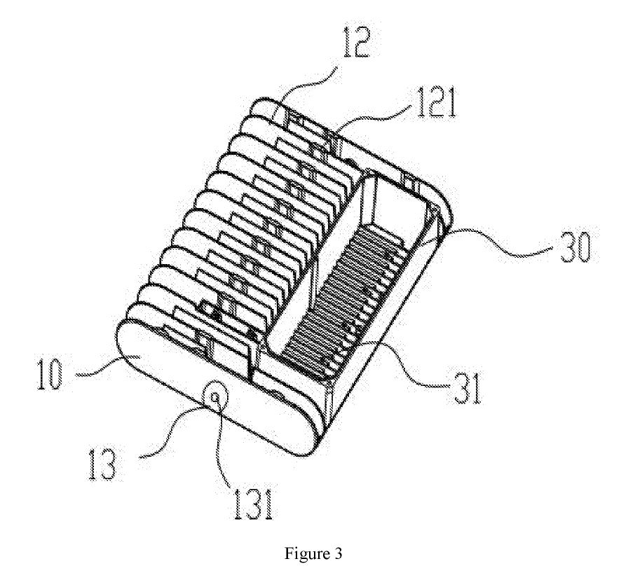

As shown in FIGS. 1-3, an intelligent energy-saving LED flood light includes housing 10, LED light board 20 provided on the upper surface of housing 10, power supply components electrically connected to LED light board 20 (which is not shown in the Figure) and U-shaped bracket 40. In the present embodiment, there are two LED light boards 20, and the two LED light boards 20 are mounted on the upper surface of housing 10 side by side and fixed to housing 10 by screws. There is a gap between two LED light boards 20 and the gap is provided with a plurality of drainage holes 11 to discharge the rainwater conveniently and avoid rainwater from infiltrating into LED light boards 20. A row of spaced radiating plates 12 are provided on the lower surface of housing 10, to dissipate the heat generated by LED light boards 20 in time, and to prevent LED light board 20 from burning out. Radiating plates 12 are provided with a plurality of strengthening ribs 121 to improve the strength of radiating plate 12. Power supply case 30 is also provided on the lower surface of housing 10, and power supply case 30 is used for accommodating the power supply components. Power supply case 30 includes a case body and power supply cover plate 32, and power supply cover plate 32 is fixed to the case body by screws. A row of protruding bars 31 are provided on the bottom wall of the case body, and the power supply components are separated from the bottom wall by the protruding bars 31, to avoid the conduction of heat generated by LED light board 20 too fast to the power supply components, thus avoiding the burn out of the power components. Radiating ribs 321 are provided on the outer wall of power supply cover plate 32 to further enhance the heat dissipation capacity of the flood light. A sealing ring 33 is provided between the case body and power supply cover plate 32 to enhance the waterproof effect and prevent the moisture from entering power supply case 30. The two sides of housing 10 of the flood light are also symmetrically provided with two engaging lugs 13, and two engaging lugs 13 are symmetrically provided with two mounting holes 131. Both ends of U-shaped bracket 40 are connected to two mounting holes 131 by screws.

The power of the intelligent energy-saving LED flood light disclosed in the present embodiment is 100 W, and is mainly used for the open areas such as industrial areas, factories, communities and parks.

### Embodiment 2

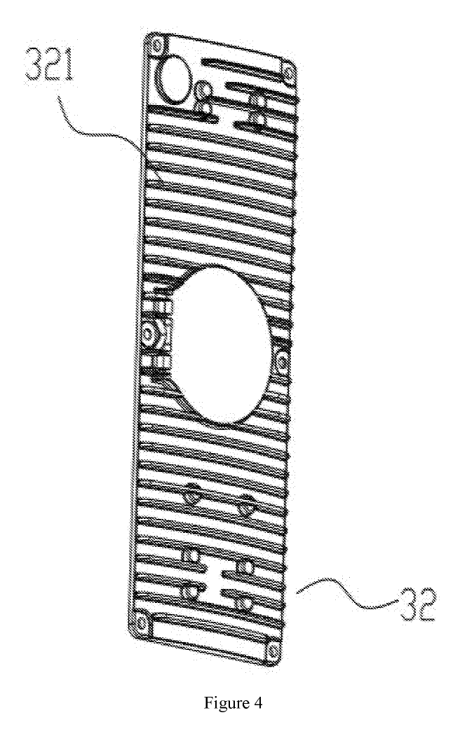

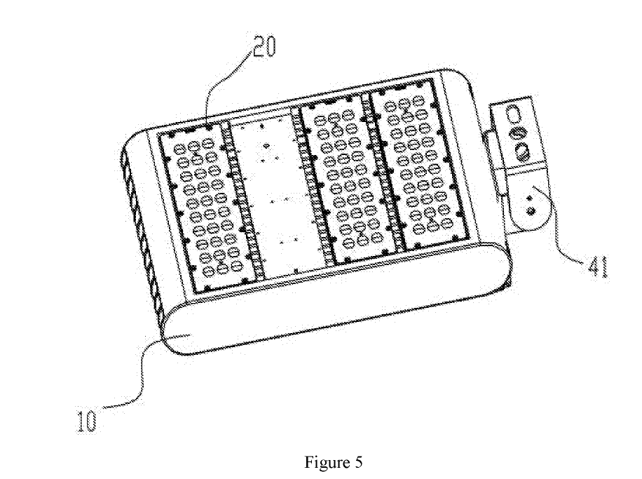

As shown in FIGS. 4-6, an intelligent energy-saving LED flood light is different from Embodiment 1 in that the power of the flood light of the Embodiment 2 is 220 W, which leads to a higher heat dissipation and a larger volume of the flood light. The intelligent energy-saving LED flood light of the present embodiment has three LED light boards 20. The three LED light boards 20 are parallelly mounted on the upper surface of housing 10. And gaps are provided between every two LED light boards 20, drainage holes 11 are provided in the gaps. And the bracket of the present embodiment is of L-shape, and one end of the bracket is fixed to the rear end surface of housing 10 by screws. L-shaped bracket 41 is form by hinging two straight arms together, and the angle of the hinge connection is adjustable. By adjusting the angle of the hinge connection, it is convenient to adjust the illumination angle of the LED flood light. The intelligent energy-saving LED flood light disclosed in the present embodiment can be easily fixed to the street light and the building.

It will be apparent to the ordinary person skilled in the art that various changes and modifications can be made based on the technical solutions and concepts described above, and all such changes and modifications shall fall within the scope of the appending claims of the present invention.

What is claimed is:

1. An intelligent energy-saving LED flood light, comprising a housing, an LED light board arranged on an upper surface of the housing, a power supply component electrically connected to the LED light board;
wherein a power supply case accommodating the power supply component and a row of spaced radiating plates are provided on a lower surface of the housing; the power supply case comprises a case body and a corresponding supply power cover; a row of protruding bars are provided on a bottom wall of the case body,
wherein the power supply component and the bottom wall of the case body are separated by the protruding bars; and a plurality of radiating ribs are provided on an outer wall of the power supply cover.

2. The intelligent energy-saving LED flood light according to claim 1, wherein the case is hermetically connected to the power supply cover.

3. The intelligent energy-saving LED flood light according to claim 1, wherein a drainage hole is provided on the upper surface of the housing.

4. The intelligent energy-saving LED flood light according to claim 1, wherein at least one strengthening rib is provided on each radiating plate.

5. The intelligent energy-saving LED flood light according to claim 1, wherein the intelligent energy-saving LED flood light further comprises a bracket, and both ends of the bracket are connected to the housing.

6. The intelligent energy-saving LED flood light according to claim 5, wherein two engaging lugs are symmetrically provided on both sides of the housing, and the two engaging lugs are symmetrically provided with a mounting hole, and both ends of the bracket are connected to the engaging lugs through the mounting hole.

7. The intelligent energy-saving LED flood light according to claim 5, wherein the bracket is L-shaped, and the bracket is formed by hinging two straight arms.
